(19) United States
(12) Patent Application Publication
(10) Pub. No.: US 2010/0194154 A1
(43) Pub. Date: Aug. 5, 2010

(54) Assist Handle for Vehicle Seat

(76) Inventors: Thomas S. Hicks, Livonia, MI (US); Jaron Rothkop, Royal Oak, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 12/678,404

(22) PCT Filed: Sep. 11, 2008
(86) PCT No.: PCT/US08/75946

§ 371 Date: Mar. 16, 2010

Related U.S. Application Data
(60) Provisional application No. 60/995,725, filed on Sep. 28, 2007.

(51) Int. Cl. B60N 2/20; B60N 2/44

(52) U.S. Cl. 297/183.2

(57) ABSTRACT

A vehicle seat assembly (10) includes a seat bottom (18) and a seat back (14, 16) movable between a stowed position and an upright position. The vehicle seat assembly (10) further includes an assist handle (20) that is movably mounted to the seat back (14, 16) and movable between a storage position and a use position for moving the seat back (14, 16) from the stowed position to the upright position.

### CROSS REFERENCE TO RELATED APPLICATIONS

This application claims the benefit of U.S. Provisional Application No. 60/995,725 filed Sep. 28, 2007.

### BACKGROUND

Various embodiments of a seat assembly are described herein. In particular, the embodiments described herein relate to an improved seat assembly for a vehicle.

Folding seats and particularly split folding seats of the type common in vehicles having a rear cargo area either allow the vehicle to seat additional occupants or provide additional cargo space. Generally, the seat is folded from an upright position to a folded position by pivoting the seat back at its lower edge and rotating the top edge forward and downward onto the seat cushion or into the area occupied by the seat cushion in its seating use position. To move the seat from the folded position to the upright position, a user typically grasps the seat back and pivots the seat back upward.

For example, U.S. Pat. No. 6,131,993 discloses a vehicle seat with a rear facing seat back panel. The panel includes a fixed grip handle integrally formed on, and extending outwardly of, the rearwardly facing surface of the seat back panel.

### SUMMARY

The present application describes various embodiments of a vehicle seat assembly. One embodiment of the vehicle seat assembly includes a seat bottom and a seat back movable between a stowed position and an upright position. The vehicle seat assembly further includes an assist handle that is movably mounted to the seat back and movable between a storage position and a use position for assisting in moving the seat back from the stowed position to the upright position.

Other advantages of the vehicle seat assembly will become apparent to those skilled in the art from the following detailed description, when read in light of the accompanying drawings.

### BRIEF DESCRIPTION OF THE DRAWINGS

FIG. 1 is a perspective view of a seat assembly having a pair of seats and an assist handle.

FIG. 2 is a perspective view of the back of the seat assembly illustrated in FIG. 1.

FIG. 3 is a perspective view of a portion of the seat assembly illustrated in FIG. 2, showing the seat assembly in a partially upright position.

FIG. 4 is an enlarged exploded perspective view of a portion of the seat assembly illustrated in FIGS. 1 and 2 showing an alternate embodiment of the assist handle.

### DETAILED DESCRIPTION

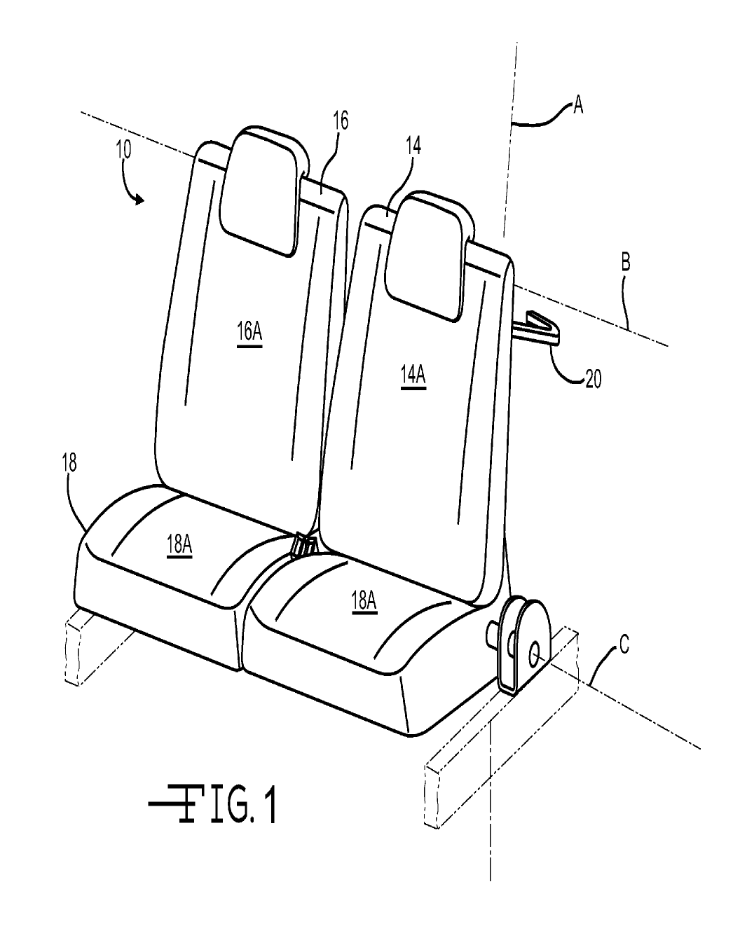

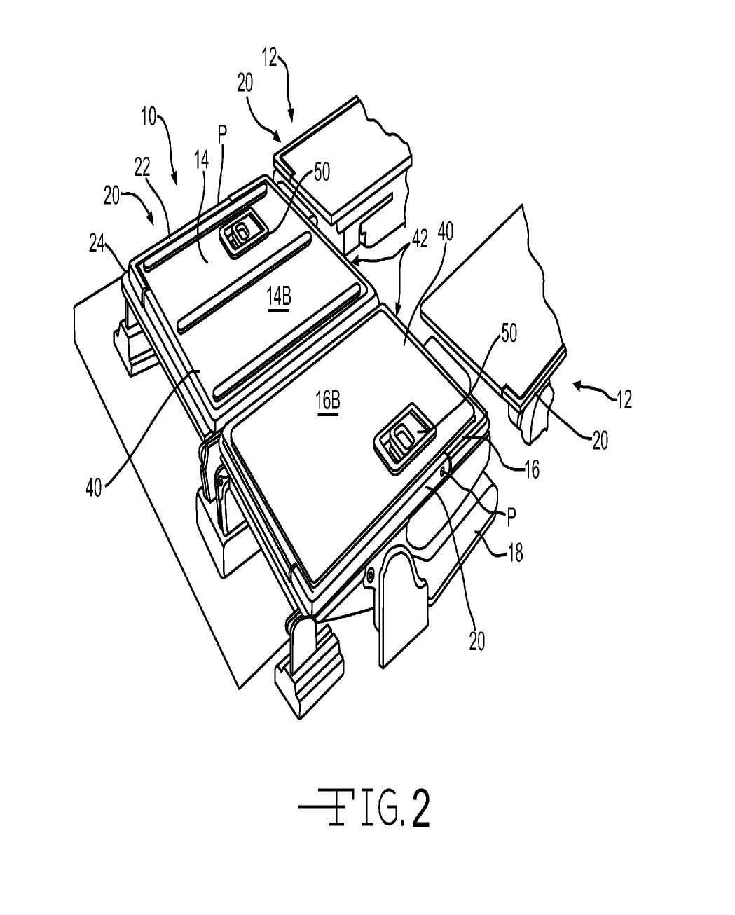

Referring now to the drawings, there is illustrated in FIG. 1 a first embodiment of a vehicle seat assembly, indicated generally at 10. The illustrated seat assembly 10 is a third row seat for a vehicle. It will be understood the vehicle seat assembly 10 may be used in any desired location in a vehicle, such as a second row seat 12, partially shown in FIG. 2. The illustrated seat assembly 10 includes a first seat back 14 and a second seat back 16. The seat backs 14 and 16 are pivotally mounted on a seat bottom 18. Alternatively, the seat back 14 may be pivotally mounted on a seat bottom separate from the seat bottom 18. As best shown in FIG. 1, the seat backs 14 and 16 define a first seat back axis A (substantially vertical when viewing FIG. 1), and a second seat assembly axis B (substantially horizontal when viewing FIG. 1).

The exemplary embodiments of the seat backs 14 and 16 are shown in a generally horizontal stowed position in FIG. 2, such that front seating surfaces 14A and 16A of the seat backs 14 and 16, respectively, are positioned against seating surfaces 18A of a seat bottom 18. In the stowed position, the seat backs 14 and 16 define a substantially flat load floor such as for storing cargo thereon. The seat backs 14 and 16 are movable between the stowed position and a generally vertically upright position as shown in FIG. 1 for supporting an occupant seated thereon.

To move the seat backs 14 and 16 from stowed positions to upright positions, the seat assembly 10 includes assist handles 20 mounted on each of the seat backs 14 and 16. In the exemplary embodiment illustrated, the assist handle 20 is mounted substantially parallel to the first seat back axis A. Alternatively, the assist handle 20 may be mounted substantially parallel to the second seat back axis B. The assist handles 20 may further be positioned, oriented, and attached to the seat backs 14 and 16 at any suitable location.

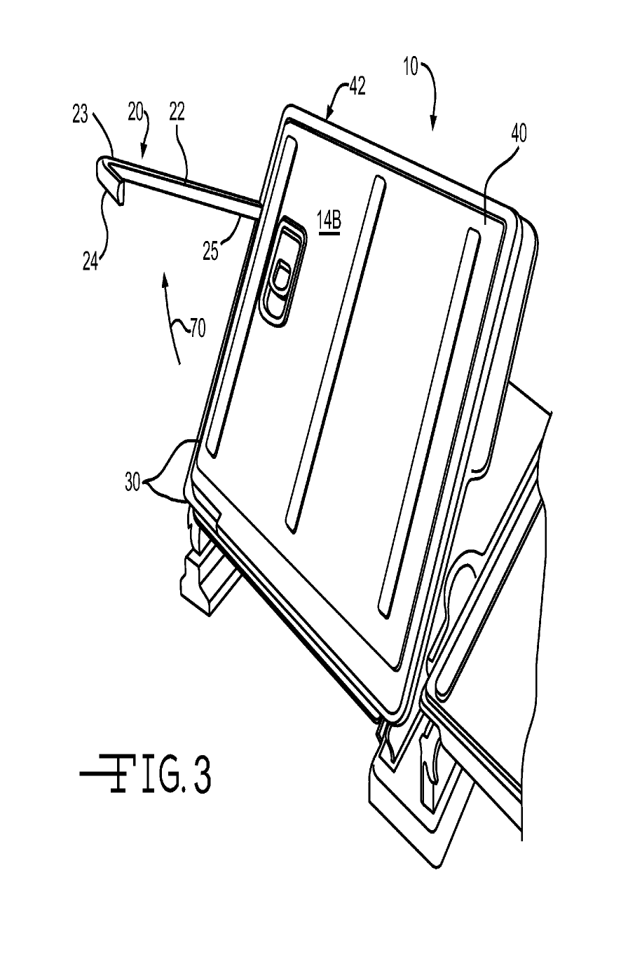

The illustrated embodiment of the assist handle 20 has a generally L-shape defining a leg 22 and a grip 24 at a first end 23 of the leg 22, as best shown in FIG. 3. A second end 25 of the illustrated embodiment of the leg 22 is pivotally mounted on an upper portion of each seat back 14 and 16 at pivot points P. The assist handle 20 may be made of a rigid material, such as plastic. It will be understood however, that the assist handle 20 may be made of any other desired material such as aluminum and other metals and non-metals. Alternatively, the assist handle may comprise a substantially flexible member or strap formed from a substantially flexible material such as for example fabric and rubber.

Although the exemplary embodiment of the grip 24 is shown attached to the leg 22 at an angle of about 90 degrees, and thereby defining a generally L-shape, the assist handle 20 may have any other desired shape. For example, the grip 24 of the assist handle 20 may be formed to have a generally T-shape (not shown), a ball shape (not shown), or the assist handle 20 may have no grip (not shown) at the first end 23 of the leg 22. Additionally, the assist handle 20 may have any desired length, such as for example, within the range of from about 50 percent to about 100 percent of the length of a side of the seat backs 14 and 16. In the exemplary embodiment illustrated in FIGS. 2 and 3, the assist handle 20 has a length within the range of from about 50 percent to about 75 percent of the length of a side of the seat backs 14 and 16. It will be understood that a person skilled in the art will be able to determine the appropriate length of the assist handle 20 through routine experimentation.

The assist handles 20 are movable from a storage position (as shown in FIG. 2) generally against the seat backs 14 and 16, and a use position (as shown in FIG. 3) in which the grip 24 is positioned outwardly from the seat backs 14 and 16. In one embodiment, the assist handles 20 are disposed in L-shaped slots or recesses 30 formed on a rearward facing surfaces 14B and 16B of the seat backs 14 and 16, respectively, when in the storage position. The recesses 30 may have any desired size corresponding to the dimensions of the assist handles 20. This provides for an aesthetically pleasing appearance and also helps to prevent the assist handles 20 from being inadvertently moved when not in use. In the illustrated embodiment, a back panel assembly 42 includes a rigid trim panel or back panel body 40 mounted on a rear surface of the seat backs 14 and 16, and the assist handle 20. The illustrated recesses 30 are formed on edges of the back panel body 40. The recesses 30 may be formed on the outboard sides of the seat backs 14 and 16, as shown in FIGS. 2 and 3. Alternatively, the recesses 30 may be formed in the seat backs 14 and 16 at any suitable location.

To use the assist handles 20 for moving the seat backs 14 and 16 from the stowed positions to the upright positions, a user may simply pivot the assist handle 20 outwardly of the recess 30 in the direction of the arrow 70, thereby moving the assist handle from a storage position to an in-use position as shown in FIG. 3. The user may then simply pull on the grip 24 in a direction away from the respective seat back 14 and 16, thereby lifting the respective seat back 14 and 16 from the stowed position. The user may then continue pulling on the assist handle 20 until the seat back 14 and 16 is in the upright position.

Once a seat back 14 and 16 is in the upright position, the assist handles 20 can be returned to the storage position. Known vehicle seats require a user to reach an extended distance into the vehicle to grasp a forward portion of the seat back and manually lift the seat backs themselves. Advantageously, the assist handles 20 provide an easy method for lifting the seat backs 14 and 16, especially when the user is behind the seat assembly, such as when standing at the rear of the vehicle at the lift-gate or tailgate of a vehicle having two or three rows of seats.

It may be desirable to pivotally mount the assist handle 20 toward the upper portion of the seat back 14 and 16 at a distance from the pivot axis C of the seat back 14 and 16 relative to the seat bottom 18 to thereby reduce the lifting force required to lift the seat backs 14 and 16. It may also be desirable to position the grip 24 toward the bottom portion of the seat backs 14 and 16 to thereby reduce the distance that the user must reach into the vehicle to grasp assist handle 20.

The assist handles 20 may simply rest against the seat back 14 and 16 or rest in the respective recesses 30 when in the storage position. Alternatively, the assist handles 20 may be biased into the storage position, such as by a spring (not shown), a detent (not shown), or clip (not shown), wherein a relatively small force is required to lift the assist handle 20 from the storage position. As another alternative, magnets (not shown) may be used to secure to assist handle 20 to the seat back 14 and 16. Magnets may be provided on one of the assist handle 20 and the seat back 14 and 16. Such a magnet may mate against a metallic portion of, or a metallic insert connected to, the other of the assist handle 20 and seat back 14 and 16. The magnets may be located anywhere along the length of the assist handle, such as for example in the grip 24.

The seat assembly 10 may or may not include a latching mechanism 50 for latching the seat backs 14 and 16 relative to the seat bottom 18 when the seat backs 14 and 16 are in any of the stowed position, the upright position, and any position therebetween.

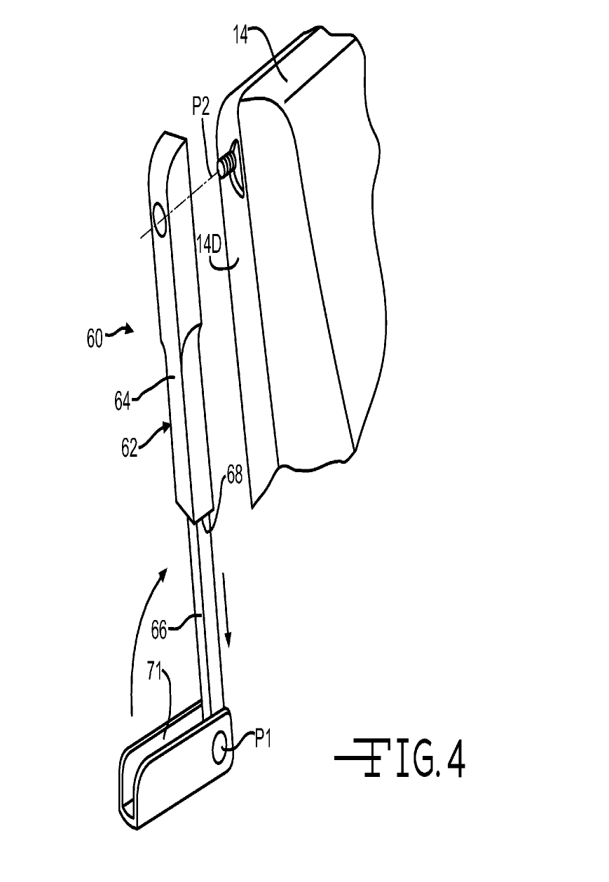

Referring now to FIG. 4, there is illustrated an alternate embodiment of the assist handle, indicated generally at 60. The illustrated assist handle 60 includes a grip 61 pivotally connected to a telescoping leg 62 at a pivot point P1. The exemplary embodiment of the telescoping leg 62 illustrated includes a first portion 64 and a second portion 66 which is slidably disposed within a slot or bore 68 formed in the first portion 64. The first portion 64 may be pivotally mounted to the seat back 14 at a pivot point P2. In the illustrated embodiment, the assist handle 60 is pivotally mounted to a side 14D of the seat back 14. It will be understood however, that the assist handle 60 may also be mounted to the rearwardly facing surface of the seat back 14. The illustrated assist handle 60 is mounted by a threaded fastener, however it will be understood that the assist handle 60 may be attached by any desired attachment means.

The telescoping feature of the assist handle 60 may provide for an increased length to the assist handle 60 beyond the edge of the bottom of the seat back 14; i.e., the assist handle 60 may have a length greater than 100 percent of the length of a side of the seat backs 14 and 16. Alternatively or additionally, the telescoping feature may provide for a decreased packaging in which the assist handle 60 takes up less space than the assist handle 20 for example, when in the storage position.

It will be understood that the pivoting connection of the assist handles 20 and 60 may be other than as illustrated. For example, the assist handles 20 and 60 may be pivotally connected to the seat back 14 such that they rotate in generally only one plane or may include a ball joint type pivoting connection for a spherical type of pivot joint. Additionally, the grips 24 and 61 of the assist handles 20 and 60, respectively, may be fixed relative to the respective legs 22 and 66, or may be pivotally connected such as shown at P1 in FIG. 4. If desired, the grip 61 may include a recess or slot 71 formed therein to accommodate being pivoted at the pivot point P1 and positioned over the second portion 66 of the leg 62 to reduce storage space.

The principle and mode of operation of the vehicle seat assembly have been described in its preferred embodiment. However, it should be noted that the vehicle seat assembly described herein may be practiced otherwise than as specifically illustrated and described without departing from its scope.

What is claimed is:

1. A vehicle seat assembly comprising:
a seat bottom;
a seat back movable between a stowed position and an upright position; and
an assist handle;
wherein the assist handle is movably mounted to the seat back and movable between a storage position and a use position for moving the seat back from the stowed position to the upright position.

2. The seat assembly according to claim 1, wherein the seat back is movably mounted to the seat bottom.

3. The seat assembly according to claim 2, wherein the seat back is pivotally mounted to the seat bottom.

4. The seat assembly according to claim 1, wherein the seat back is pivotally movable relative to the seat bottom.

5. The seat assembly according to claim 1, wherein the assist handle is pivotally mounted to the seat back.

6. The seat assembly according to claim 5, wherein the assist handle is telescoping.

7. The seat assembly according to claim 1, wherein the assist handle is mounted to the seat back with a spherical bearing.

8. The seat assembly according to claim 1, wherein the seat back defines a first axis and a second axis, and wherein the assist handle is mounted substantially parallel to the first axis.

9. The seat assembly according to claim 1, wherein the seat back defines a first axis and a second axis, and wherein the assist handle is mounted substantially parallel to the second axis.

10. The seat assembly according to claim 1, wherein the seat back further includes a recess formed in a rearward facing surface thereof; and
wherein the assist handle is disposed within the recess in the storage position.

11. The seat assembly according to claim 1, wherein in the assist handle is formed from a substantially flexible material.

12. The seat assembly according to claim 1, wherein in the assist handle includes a leg and a grip; and
wherein the grip is pivotally mounted to the leg.

13. A seat back panel assembly for a seat back movable between a stowed position and an upright position, the seat back panel comprising:
a seat back panel body; and
an assist handle;
wherein the assist handle is movably mounted to the seat back panel assembly and movable between a storage position and a use position for assisting in moving the seat back from the stowed position to the upright position.

14. The back panel assembly according to claim 13, wherein the assist handle is pivotally mounted to the seat back panel body.

15. The back panel assembly according to claim 14, wherein the assist handle is telescoping.

16. The back panel assembly according to claim 13, wherein the assist handle is mounted to the seat back panel body with a spherical bearing.

17. The back panel assembly according to claim 13, wherein the seat back defines a first axis and a second axis, and wherein the assist handle is mounted substantially parallel to the first axis.

18. The back panel assembly according to claim 13, wherein the seat back defines a first axis and a second axis, and wherein the assist handle is mounted substantially parallel to the second axis.

19. The back panel assembly according to claim 13, wherein the seat back panel body further includes a recess formed in a rearward facing surface thereof; and
wherein the assist handle is disposed within the recess in the storage position.

20. The back panel assembly according to claim 13, wherein in the assist handle is formed from a substantially flexible material.
